(19) United States
(12) Patent Application Publication
(10) Pub. No.: US 2016/0008965 A1
(43) Pub. Date: Jan. 14, 2016

(54) TOOL

(71) Applicant: RELIANCE WORLDWIDE CORPORATION (AUST.) PTY. LTD., Melbourne, Victoria (AU)

(72) Inventors: Jeremy Gledhill, Moorabbin, Victoria (AU); Peter Graham, Evesham, Worcester (GB)

(21) Appl. No.: 14/770,268

(22) PCT Filed: Feb. 26, 2014
(86) PCT No.: PCT/AU2014/000179

§ 371 Date: Aug. 25, 2015

(30) Foreign Application Priority Data
Feb. 27, 2013 (AU) 2013900696

(51) Int. Cl. B25B 27/10; G01B 3/30

(52) U.S. Cl. CPC B25B 27/10; G01B 3/30

(57) ABSTRACT

A tool (10) for use with a cylindrical tube (12) and tube coupling (20), the tool (10) including a first abutment (25) for abutting a demount ring (18) of the tube coupling (20) and a second abutment (26) for abutting an end (27) of a tube (12). The second abutment (26) being spaced from a marking face (28), whereby the spacing between the second abutment (26) and the marking face (28) is equal to the required depth of insertion of a tube end (11) into the tube coupling (20).

### FIELD OF THE INVENTION

The present invention relates to a tool for use with a tube and tube coupling assembly.

### BACKGROUND OF THE INVENTION

Tube couplings can be used to connect tubes or conduit (hereinafter “tubes” or “tubing”), such as metal or plastic plumbing tubes to each other, or to fittings such as valves or flow meters. Tube couplings can thus be used to connect tubes in end-to-end connection, or they can be used to route tubes at particular angles. For example, tube couplings can be employed to change the direction of tubing, such as by 45° or 90°. In addition, tube couplings can be employed to branch or split tubing in different directions. For example, a single tube can be connected by a T-fitting or a Y-fitting, each of which branches that tube into two separate tubes. Other fittings can branch a single tube into more than two tubes.

Couplings of the above kind can have a gripping arrangement in which the end of a tube is gripped against release from the tube coupling once it is inserted into the tube coupling. Tube couplings normally include a grab ring for that purpose. The grab ring engages against the outside surface of the tube end that is inserted into the tube coupling and grabs the surface to prevent release. The grab ring normally includes a plurality of teeth which grab the surface. Tube couplings of this kind also include a demount ring that can be pushed into the coupling to disengage the grab ring from the surface of the tube to allow the tube end to be released from the coupling. The demount ring is normally formed as a permanent part of the tube coupling, like the grab ring.

The demount ring can be shifted to engage the grab ring by any suitable tool. Tools not specifically meant for that purpose can be used, such as screwdrivers or pliers. Alternatively, a tool specifically for demount ring displacement can be applied.

For the grab ring to properly grip the outside surface of the tube, the end of the tube needs to be inserted into the tube coupling a sufficient amount, which at a minimum is to a position which is just past the grab ring. However, tube couplings normally also include an O-ring seal inboard of the grab ring to seal against leakage from the coupling, and it is important for the tube end to extend into contact with and past the O-ring seal for proper sealing. Thus, the end of the tube needs to be inserted into the tube coupling far enough to move past both the grab ring and the O-ring seal.

A difficulty for installation personnel is to identify when a tube has been sufficiently inserted into a tube coupling for proper sealing. Most tube couplings of the above described kind include a lip or recess or other abutment that the leading end of the tube abuts when it has reached the point of full insertion into the tube coupling. However, resistance to insertion is met is when the tube end engages grab ring and then the O-ring seal and often the installer will wrongly think that the tube end has been fully inserted when in fact it has only been partially inserted either to the position of engaging the grab ring, or to the position of engaging the O-ring seal. Because of this, tubes are not always inserted properly into a tube coupling.

In addition, the personnel that install tubes to tube couplings are often the same personnel that need to disassemble the installation. As a result, Applicant has identified a need in the marketplace for a tool that can assist such personnel to properly assemble and disassemble a tube and tube coupling assembly.

### SUMMARY OF THE INVENTION

According to the present invention, there is provided a tool for use with a tube and tube coupling assembly, the tool including a first abutment for abutting a demount ring of the tube coupling assembly and a second abutment for abutting an end of a tube, the second abutment being spaced from a marking face, the spacing between the second abutment and the marking face being equal to the required depth of insertion of a tube end into the tube coupling.

A tool according to the invention advantageously can be employed for ensuring that the depth of insertion of a tube end into a tube coupling is sufficient and optimal by providing a marking face that allows a mark to be made on the surface of the tube at a position spaced from the leading edge of the tube which shows how far the tube needs to be inserted into the tube coupling. Thus, once the mark is made, the tube end can be inserted into the tube coupling and once the mark reaches the opening of the tube coupling, the installer will have an indication that the appropriate insertion depth has been reached. Advantageously, the mark can be made by a pen, pencil or other marker (such as a screw driver applying a scratch to the surface of the tube) so that marking is very simple and quick.

Moreover, the tool can be employed to engage and displace a demount ring for the purpose of releasing a grab ring from gripping the outside surface of a tube so that the tube can be released from the tube coupling.

Thus, the tool can advantageously assist installation personnel in the assembly and disassembly of a tube and tube coupling assembly.

A tool according to the invention can have a variety of different configurations. Preferably, the tool is relatively small and lightweight, but also robust. The tool can be formed from plastic or metal for example, but plastic is preferred. This enables the weight and cost of the tool to be minimised, but allows the tool to be made from hardwearing plastics so that a long life can be expected. The use of plastic also enables the tool to be made in different colours that might be useful to differentiate between tools of different sizes, and for the tool to contain any appropriate marking, such as sizing and instructions for use.

The demount ring typically will present a circular edge for engagement by the first abutment. The first abutment can engage the demount ring edge in any suitable manner, but in some forms of the invention, the first abutment forms a part circular abutment, so that it can abut a portion of the demount ring edge. The first abutment can be a continuous abutment which forms an abutment face, or it can be formed of a plurality of abutment portions or projections which form an interrupted abutment face. Such abutment portions or projections can be spaced apart about a part circular path. Regardless of whether the abutment face is formed as a continuous face or an interrupted face, an abutment face is formed.

The extent to which the first abutment engages the edge of the demount ring can be of any suitable extent to effect movement of the demount ring to disengage the grab ring from the outside surface of a tube. Engagement of the complete edge of the demount ring is not required, but engagement of about half the ring or more is preferred. In some forms of the invention, approximately 50-70% of the demount ring edge can be engaged. In other forms of the invention, less than 50% of the demount ring edge can be engaged, such as about 40% or 30%.

In some forms of the invention, the first abutment is closely adjacent the second abutment. This can be achieved in some forms of the invention by the first abutment being substantially perpendicular to the second abutment. While this also can be achieved in a variety of arrangements, in some forms of the invention, the first abutment can be formed at an edge of an opening in the tool in which the opening is formed to fit about, preferably closely about a portion of the outside surface of a tube, and the second abutment is formed adjacent the first abutment substantially perpendicular thereto.

The opening mentioned above is provided to conveniently locate the tool on a tube, preferably being able to slide along the outside surface of the tool and in preferred arrangements, the opening is formed to fit closely about a major portion of the outside surface of the tube, wherein a major portion is anything more than 50% of the complete circumference of the tube. In this arrangement, the tool can be attached to the tube by the tool resiliently flexing to accept the tube within the opening, so that the tool is clipped onto the tube resiliently and releasably. This provides advantages in that once the tool is attached to the tube, it will remain attached until it is unclipped from the tube. The tool can alternatively hinge to an open position but the use of a hinge can add complexity to the tool and thereby increase its cost.

It should be noted that the opening can be formed to fit closely about less than 50% of the complete circumference of the tube and still operate adequately, but the benefits of attachment to the outside surface of the tube will be lost unless an alternative attachment mechanism is provided,

Where the first abutment is formed at an edge of an opening in the tool, the second abutment can be formed either to be upstanding from the first abutment, or to be inboard of the first abutment. In some forms of the invention, the first abutment can be formed by an abutment face which surrounds part or all of the opening and the second abutment can be formed by a face of a projection that extends from the abutment face of the first abutment. The abutment face of the first abutment can be a part annular face and can be substantially planar regardless of whether the abutment face is formed as a continuous face or an interrupted face.

Where the tool includes an opening which is formed to fit closely about a portion of the outside surface of the tube with which the tool is to be used, the tool can include a rim which defines that opening. The rim can have a continuous or an interrupted face as described above which forms the first abutment and can have a second face or surface which is substantially perpendicular to the first face and which forms the second abutment. The second face or surface can be just a small portion of the rim and can be of much reduced extent compared to the extent of the first abutment of the rim. The first face of the rim can be substantially planar and in use, with the tool fitted to the outside surface of the tube, the first face will face generally in the same direction as the axis of the tube.

Tools according to the invention can also include a support which is positioned intermediate the second abutment and the marking face. The support can include a curved bearing surface for bearing against the outside surface of a tube and which is curved to be substantially complementary to the curve of the outside surface of the tube. The curve of the support can be substantially the same as the curve of the opening of the tool (as described above), if provided. A support which is formed in the above manner assists to easily locate the tool in position on the outside surface of a tube for marking the tube. While the support can be positioned anywhere between the second abutment and the marking face, in some forms of the invention, it is substantially central between those two components.

An alternative arrangement of the invention can be provided in which a portion of the tool is formed as a collar or part collar, that is a close fit about the outside of the tube of the tube and tube coupling assembly with which the tool is to be used and the marking face is formed at one end of the collar and the second abutment is formed inboard of the marking face at the required distance. In this arrangement, the collar or part collar portion of the tool can be inserted over the end of the tube and slid onto the tube until the second abutment is engaged and then a mark can be applied on the surface of the tube as described with the examples of the invention described above.

The marking face can also extend to a bearing surface, which is preferably a curved bearing surface for bearing against the outside surface of a tube and the curvature of the bearing surface can be substantially complementary to the outside surface of the tube. Like the support, this assists to locate the tube in place for applying a marking to the surface of the tube. That is, the tool is supported on the outside surface of the tube at two points by the support and the bearing surface to which the marking face extends.

Still further, the second abutment can extend to a curved bearing surface which functions in the same way as the curved bearing surfaces of the support and the marking face. Thus, three points of contact can be made between the tool and the outside surface of a tube when the tool is being used for marking purposes, and each of those points of contact can be curved complementary to the outside surface of the tube for secure location.

It is to be appreciated that the curved bearing surfaces which are discussed above and which are associated with the support, the marking face and the second abutment, do not each need to be provided. One or more can be provided and still provide a functional advantage for the proper location of the tool on the outside surface of a tube.

In other forms of the invention, the tool includes front and rear faces and includes a concave depression on the rear face which extends from the second abutment to the marking face. The depression has a concave curve which is curved substantially complementarily to the outside surface of the tube. The depression can be a solid or continuous depression, or it can be formed by spaced apart ribs or walls or a combination.

The actual physical shape of the tool can have a variety of forms. In some forms, the tool includes a pair of extensions formed to extend on each side of a tube to present push surfaces by which the tool can be pushed manually to engage the first abutment with the demount ring of the tube coupling. One or both of these extensions of the tool can extend to the marking face, so that the marking face is conveniently formed as part of another functional component of the tool. The extensions can extend on either side of an opening provided in the tool of the kind described above and the tool can be symmetrical about the opening.

In an alternative form of the tool, the tool can still include first and second extensions which are formed to extend on each side of a tube to present push surfaces for pushing the tool into engagement with a demount ring, but in this form of the tool, the second abutment is intermediate or substantially central between the first and second abutments. This form of tool can include a third extension which extends in the general direction of the axis of the tube and that third extension can extend to the marking face. Again, the extensions can extend on either side of an opening provided in the tool of the kind described above and the tool can be symmetrical about the opening.

The provision of push surfaces readily assists installation personnel to disengage the grab ring from the surface of a tube.

### BRIEF DESCRIPTION OF THE DRAWINGS

For a better understanding of the invention and to show how it may be performed, embodiments thereof will now be described, by way of non-limiting example only, with reference to the accompanying drawings.

FIG. 1 is a perspective view of a tool according to the invention in contact with a tube.

FIG. 2 is a side view of the FIG. 1 arrangement.

FIG. 3 is a side cross-sectional view of the FIG. 1 arrangement.

FIG. 4 is a cross-sectional view of a tube coupling for which the tool of the present invention can be employed.

FIG. 5 is an isometric view taken of the tool of FIG. 1 shown from the underneath side of the tool.

FIG. 6 is a perspective view of an alternative form of tool according to the invention in contact with a tube.

FIG. 7 is a cross-sectional view the FIG. 6 arrangement.

### DETAILED DESCRIPTION OF THE DRAWINGS

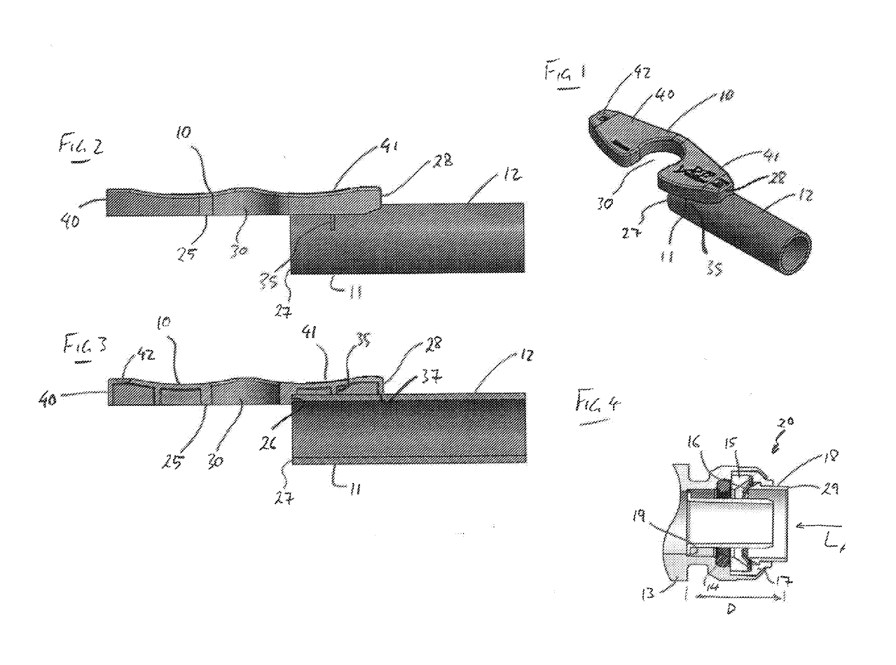

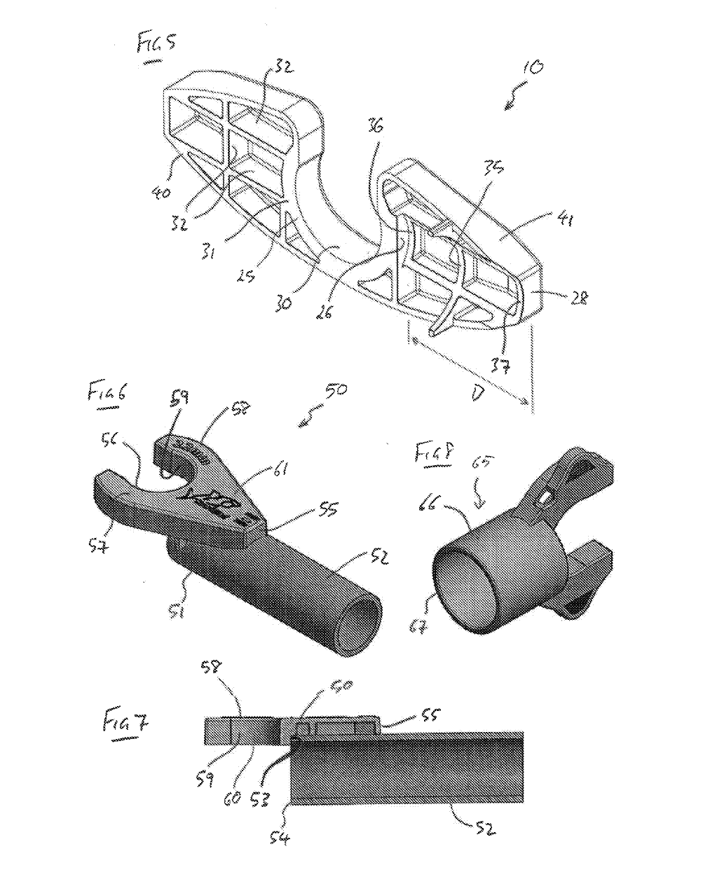

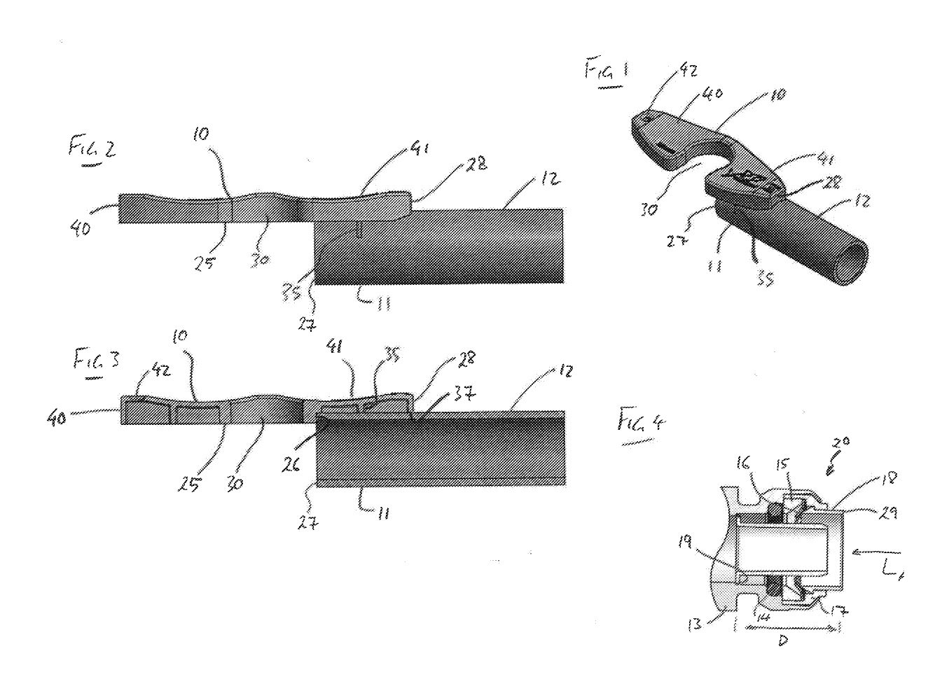

FIG. 1 illustrates a first embodiment of the invention and illustrates a tool 10 which is applied to the leading end 11 of a tube 12. A side view of the arrangement of FIG. 1 is shown in FIG. 2, while FIG. 3 illustrates a cross-sectional side view of the FIG. 1 arrangement. FIG. 4 is a cross-sectional illustration of a tube coupling, to which the leading end 11 of the tube 12 can be inserted.

Referring to FIG. 4, the tube coupling 20 comprises an outer housing 13, an O-ring seal 14, a spacer 15, a grab ring 16, a cartridge ring 17 and a demount ring 18.

15

The construction of the tube coupling 20 of FIG. 4 is part of the prior art and would be well known to a person skilled in the art. Accordingly, the operation of the tube coupling 20 can be described quite briefly as follows.

The leading end 11 of the tube 12 can be pushed into the tube coupling 20 in the direction of the arrow A and as the leading end 11 enters the tube coupling 20, it engages the teeth of the grab ring 16 and forces them radially outward. The teeth of the grab ring 16 act like a barb, in that they allow the end 11 to be inserted in the direction A, but grip the outside surface of the leading end 11 against retraction in the opposite direction.

Further entry of the leading end 11 into the tube coupling 20 brings the leading end 11 into engagement with the O-ring seal 14, which seals against the outside surface of the leading end 11. The leading end 11 is intended to be inserted up until the point that it engages against the step 19, at which point, it is fully inserted.

As discussed above, it can be difficult for installation personnel to know when the leading end 11 has been sufficiently inserted to engage the step 19. Resistance to insertion of the leading end 11 occurs upon engagement of the teeth of the grab ring 16 and on engagement with the O-ring seal 14. At each of these engagement points, installation personnel may believe that the leading end 11 has been properly inserted. This is particularly the case when the installation personnel are working quickly and under pressure. Where the leading end 11 is not sufficiently inserted, the leading end might not be properly grabbed by the grab ring 16 or sealed by the O-ring 14. In either case, this can compromise the performance of the installation and can lead to leakage or even disengagement between the tube 12 and the tube coupling 20. The present invention thus provides a gauge to allow installation personnel to mark the outside surface of the leading end 11 in a manner that enables them to correctly determine when the leading end has been properly inserted into a tube coupling 20.

Before describing FIGS. 2 and 3, reference will be now made to FIG. 5, which is an isometric view of the tool 10 of FIG. 1, taken from the underneath side of the tool 10. Thus, FIG. 5 illustrates the tool 10 and shows that the tool 10 includes a first abutment 25 for abutting the demount ring 18 of a tube coupling, and a second abutment 26 for abutting the leading edge 27 of the tube 12 (see FIGS. 1 to 3). The second abutment 26 is spaced from a marking face 28 an amount D as show in FIGS. 4 and 5. It will thus be apparent, that by the application of the tool 10 to the leading end 11 of the tube 12 as shown in FIGS. 1 to 3, and by the application of a mark to the outside surface of the tube 12 at the marking face 28, the extent to which the leading edge 27 of the tube 12 must be inserted into the tube coupling 20 can easily be determined. By using the tool in this manner, the leading edge 27 can be placed so that it abuts against the abutment surface 26 (see FIG. 3) and that will position the marking face 28 at the position shown in FIG. 1 relative to the tube 12, whereby the outside surface of the tube 12 can be marked with a pen or pencil or the like or scratched and that marking will show the installer the depth to which the leading end 11 has to be inserted into the tube coupling 20 for proper installation. The marking process is very simple but by making that marking, a very effective mechanism is provided to ensure proper installation between a tube and tube coupling.

The tool 10 according to the invention also provides a mechanism in the form of an abutment for engaging a demount ring for disengaging a tube from a tube coupling. In the figures which depict the tool 10, the abutment is the first abutment 25 which is formed as a part circular abutment for engagement with a significant portion of the leading edge 29 of the demount ring 18 (FIG. 4). As will be evident from FIG. 5, the first abutment 25 will engage approximately 60% of the leading edge 29. It will be appreciated however, that a lesser or greater percentage of engagement can be employed, and while the abutment 25 is shown to be formed as a continuous abutment, it could be formed in abutment portions, such as a series of projections.

The first abutment 25 is formed at an edge of an opening 30 which is of a diameter to fit closely about the outside surface of the tube 12. Thus, the diameter of the opening 30 is slightly greater than the outside diameter of the tube 12. Formation of the opening 30 in the manner shown in FIG. 5 advantageously allows the tool 10 to be releasably attached to the tube 12 because the opening 30 is arranged to fit about a major portion of the outside surface of the tube 12, where a major portion is greater than 50% of the complete circumference of the tube 12. Because the opening 30 engages to about 60% of the complete circumference of the tube 12, and because the tool 10 can resiliently deform, the tool can be clipped onto the tube 12 resiliently and releasably. In this respect, while the tool can be formed of any suitable material, plastic is preferred, as this enables the tool to be easily manufactured by molding and to be made out of lightweight but hardwearing material. It also enables resilient flexing for the purpose described above.

With the tool 10 clipped onto the outer surface of the tube 12, the tool can be advanced into engagement with the leading edge 29 of the demount ring 18 and then advanced further to shift the demount ring to engage the teeth of the grab ring 16, and thus to allow withdrawal of the leading end 11 of the tube 12 from the tube coupling 20.

It can be seen from FIG. 5, that the first abutment 25 is substantially perpendicular to the second abutment 26. Also, in FIG. 5, the second abutment 26 is formed inboard of the first abutment 25. In alternative forms of the invention, the second abutment 26 could be formed as a projection, which is upstanding from the first abutment 25. The first abutment 25 is formed by a part annular face which is substantially planar. In the alternative, the first abutment 25 is formed by the face of a rim 31 that defines the opening 30. The rim 31 forms the planar face of the first abutment 25 and forms the perpendicular face which forms the second abutment 26. The face of the rim 31 faces in generally the same direction as the longitudinal axis of the tube 12.

The underneath side of the tool 10 shown in FIG. 5 includes a series of ribs 32, which extend perpendicular to one another, and which allow the tool to be relatively hollow but stiff. This reduces the amount of material of the tool, but retains its strength and robustness.

FIG. 5 also shows a support 35 which is positioned intermediate the second abutment 26 and the marking face 28. As illustrated, the position is substantially central between the abutment 26 and the marking face 28, but it could be closer to or further away from the marking face 28.

The support 35 is curved substantially complementary to the curve of the outside surface of the tube 12. Likewise, each of the second abutment 26 and the marking face 28 extend to a curved bearing surface respectively illustrated by reference numerals 36 and 37. Each of the support 35 and the bearing surfaces 36 and 37 has the same radius of curvature. The arrangement of the support 35 and the curved bearing surfaces 36 and 37 enables the tool to be easily and securely located on the tube 12 as shown in FIGS. 1 to 3. The location is by bearing against the outside surface of the tube 12 under pressure. This is important so that the tool 10 can be held in place easily and a mark applied to the outside surface of the tube 12.

In alternative arrangements, particularly if the tool is formed as a solid plastic or metal tool, the arrangement discussed above in relation to the support 35 and the curved bearing surfaces 36 and 37 could be provided by a concave depression which extends from the marking face 28 back to the second abutment 26. The curve of the concave depression would be substantially of the same radius of the radius of the tube 12. The arrangement of the support 35 and the curved bearing surfaces 36 and 37 effectively forms a concave depression, but by spaced apart components rather than a continuous surface.

The tool 10 includes a pair of extensions 40 and 41 which are formed on each side of the opening 30 which present push surfaces (on the opposite side of the tool 10 as shown in FIG. 5) by which the tool 10 can be pushed manually to engage the first abutment 25 with the leading edge 29 of the demount ring 18. It will be appreciated that the extension 41 extends to the marking face 28. In the extension 40, an opening 42 (see FIG. 1) is provided and this can be for the purpose of attaching the tool 10 to a ring or cord, for example so that a series of tools for different diameter tubes can be maintained together.

Returning now to FIGS. 2 and 3, FIG. 3 shows the leading edge 27 of the leading end 11 in abutment with the second abutment 26. FIG. 3 also shows the outside surface of the leading end 11 adjacent the leading edge 27 in bearing engagement with the curved bearing surface 36 (not marked on FIG. 3 but shown on FIG. 5).

Likewise, the outer surface of the leading end 11 is also in bearing engagement with the support 35 and the bearing surface 37. In FIG. 2, it can be seen that the support 35 extends over a greater portion of the outside surface of the tube 12 than the bearing surfaces 36 and 37.

With the tool 10 in the position shown in FIGS. 1 to 3, a mark can be made at the end of the marking face 28 on the outside surface of the tube 12. The leading end 11 of the tube 12 can then be inserted into the tube coupling, until the leading edge 29 of the demount member reaches the marking which was applied to the outside surface of the tube 12. When the leading edge 29 of the demount member reaches that marking, there has been proper insertion of the leading end 11 into the tube coupling.

The tool 10 has thus been effective in ensuring that installation personnel are aware of the extent to which the leading end 11 of the tube 12 needs to be inserted into the tube coupling 20 to engage the leading edge 27 of the tube 12 with the step 19 of the coupling.

Conversely, when disengagement of the tube 12 from within the tube coupling is required, the opening 30 can be engaged about the outside surface of the tube 12 and the tool 10 can be pushed axially of the tube 12 to bring the first abutment 25 into engagement with the leading edge 29 of the demount ring 18. Further advancement of the tool 10 will push the demount ring 18 into engagement with the teeth of the grab ring 16 so as to allow the tube 12 to be withdrawn from the tube coupling 20.

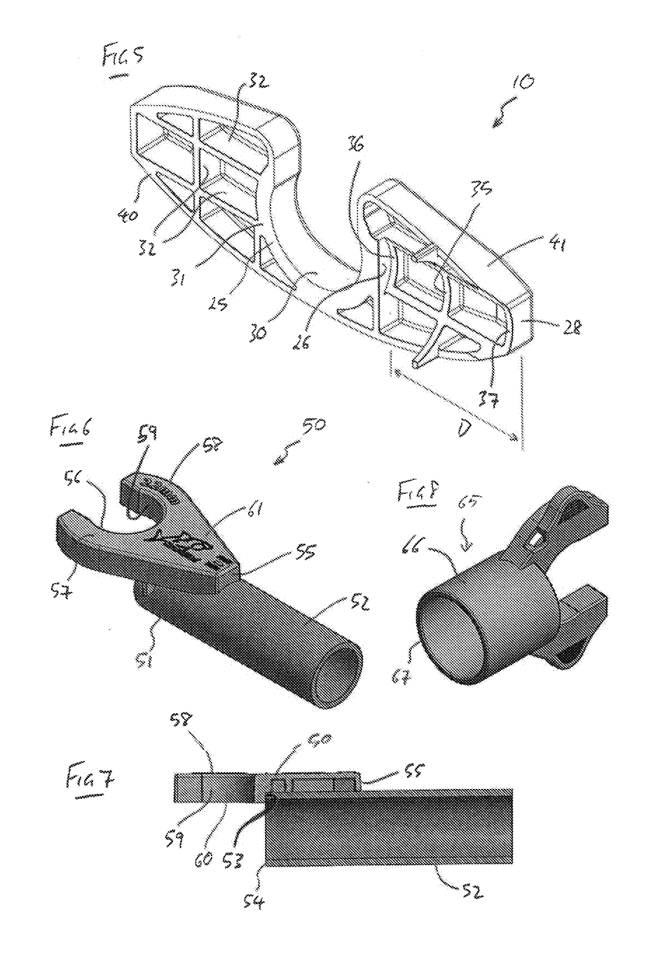

FIG. 6 illustrates an alternative shape of tool 50 which operates in substantially the same way as the tool 10. In FIG. 6, the tool 50 is shown applied to the leading end 51 of a tube 52 and from FIG. 7, it can be seen that the tool 50 includes an abutment in the form of a second abutment 53 for engaging the leading edge 54 of the tube 52 and a marking face 55 which is spaced from the second abutment 53. The relationship between the second abutment 53 and the marking face 55 is the same as the relationship between the second abutment 26 and the marking face 28 of the tool 10 and therefore no further discussion will be made in relation to that aspect of the tool 50.

The major departure from the tool 50 from the tool 10, is the construction of the opening 56, which is positioned quite differently to the opening 30 of the tool 10. In FIG. 6, the opening is formed between a pair of extensions 57 and 58 and the opening 56 defines an inside surface 59 that is of a radius slightly larger than the outside diameter of the tube 52, so that the opening 56 can be fitted closely about the outside surface of the tube 52 and the extensions 57 and 58 will resiliently flex to allow the opening to accept the tube 52 and for the tool 50 to attach to the tube 52. The surface surrounding the opening 56 defines a first abutment 60, which, when the tool 50 is attached to the tube 52, can be used to abut the leading edge of a demount ring to shift the demount ring into a tube coupling to disengage the grab ring of the coupling from the outside surface of a tube. Again, the relationship between the opening 56 and first abutment is substantially the same as the opening 30 and the first abutment 25 of the tool 10.

The tool 50 includes a third extension 61 which extends to the marking face 55 but in terms of operation, the tools 10 and 50 operate in the same manner. Thus, the tool 50 is positioned as shown in FIGS. 6 and 7 against the outside surface of the tube 52 and a mark is made at the end of the marking face 55 on the outside surface of the tube 52. The leading end 51 of the tube 52 can then be inserted into a tube coupling as described in relation to the tube 12 above.

In another alternative arrangement of the invention illustrated in FIG. 8, a tool 65 has the portion of the tool 10 of FIGS. 1 to 3 between the second abutment 26 and the marking face 28 formed as a collar or part collar 66, that is formed for a close fit about the outside of the tube (the tube 11 of FIGS. 1 to 3 for example) and the marking face 67 is formed at the end of the collar 66 remote from the second abutment, which is formed by a closed inner end of the collar 66. In this arrangement, the collar or part collar portion 66 of the tool 65 can be inserted over the end of a tube and slid onto the tube until the second abutment is engaged against the leading edge of the tube (the leading edge 27 of FIGS. 1 to 3 for example) and then a mark can be applied on the surface of the tube. This tool 65 otherwise works in the same manner as the tool 10 of FIGS. 1 to 3, but is of a slightly different construction.

The invention described herein is susceptible to variations, modifications and/or additions other than those specifically described and it is to be understood that the invention includes all such variations, modifications and/or additions which fall within the spirit and scope of the present disclosure.

1. A tool for use with a cylindrical tube and tube coupling assembly, the tool including a first abutment for abutting a demount ring of the tube coupling, the first abutment being formed at an edge of an opening in the tool which is formed to fit closely about a portion of the outside surface of the tube of the tube and tube coupling assembly, and a second abutment for abutting an end of a tube, the second abutment being formed adjacent the first abutment to face substantially perpendicular to the first abutment, the second abutment being spaced from a marking face, the spacing between the second abutment and the marking face being equal to the required depth of insertion of a tube end into the tube coupling.

2. A tool according to claim 1, the first abutment being a part circular abutment.

3. A tool according to claim 1, the first abutment being formed of a plurality of abutment portions.

4. (canceled)

5. (canceled)

6. A tool according to claim 1, the opening in the tool being formed to fit closely about a major portion of the outside surface of the tube of the tube and tube coupling assembly so that the tool can be clipped onto the tube resiliently to releasably attach to the tube.

7. A tool according to claim 1, the second abutment being upstanding from the first abutment.

8. A tool according to claim 7, the first abutment being formed by a face surrounding the opening and the second abutment being formed by a face of a projection that extends from the face of the first abutment.

9. A tool according to claim 8, the face forming the first abutment being substantially planar.

10. A tool according to claim 1, the second abutment being formed inboard of the first abutment.

11. A tool according to claim 10, the first abutment being formed by a face surrounding the opening and the second abutment being formed inboard of the face of the first abutment.

12. A tool according to claim 1, the tool including a rim which defines the opening in the tool, the rim having a first face which forms the first abutment and a second face, which faces substantially perpendicular to the first face, which forms the second abutment.

13. A tool according to claim 12, the first face of the rim being substantially planar and when the tool is fitted to the outside surface of the tube, the first face faces in the same general direction as the axis of the tube of the tube and tube coupling assembly.

14. A tool according to claim 1, the tool including a support intermediate the second abutment and the marking face which has a curved bearing surface for bearing against the outside surface of the tube of the tube and tube coupling assembly, the curved bearing surface being curved substantially complementarily to the outside surface of the tube for which the tool is for use.

15. A tool according to claim 14, the support being substantially central between the second abutment and the marking face.

16. A tool according to claim 1, the marking face extending to a curved bearing surface for bearing against the outside surface of the tube of the tube and tube coupling assembly, the curved bearing surface being curved substantially complementarily to the outside surface of the tube for which the tool is for use.

17. A tool according to claim 1, the second abutment extending to a curved bearing surface for bearing against the outside surface of the tube of the tube and tube coupling assembly, the curved bearing surface being curved substantially complementarily to the outside surface of the tube for which the tool is for use.

18. A tool according to claim 1, the tool including a support intermediate the second abutment and the marking face which has a curved bearing surface and each of the marking face and the second abutment extending to curved bearing surfaces, each of the bearing surfaces of the support, the marking face and the second abutment being recessed inboard of the first abutment.

19. A tool according to claim 1, the tool including a front and rear faces and including a concave depression on the rear face, the concave depression extending from the second abutment to the marking face and having a concave curve which is curved substantially complementarily to the outside surface of the tube for which the tool is for use.

20. A tool according to claim 1, the tool including a pair of extensions formed to extend on each side of the tube of the tube and tube coupling assembly to present push surfaces by which the tool can be pushed manually to engage the first abutment with the demount ring of the tube coupling, at least one of the extensions of the tool extending to the marking face.

21. A tool according to claim 1, the tool including first and second extensions formed to extend on each side of the tube of the tube and tube coupling assembly to present push surfaces by which the tool can be pushed manually to engage the first abutment with the demount ring of the tube coupling, the second abutment being intermediate the first and second extensions, the tool including a third extension which extends in the general direction of the axis of the tube of the tube and tube coupling assembly to the marking face.
